(19) United States
(12) Patent Application Publication
(10) Pub. No.: US 2005/0237207 A1
(43) Pub. Date: Oct. 27, 2005

(54) Alarm system for detecting the lack of activity and automatically notifing another party

(76) Inventors: Timothy Gene Gilbert, Erie, CO (US); Alan Brad Kahn, Boulder, CO (US)

Correspondence Address: Timothy G. Gilbert, 125 Stearman Court, Erie, CO, 80516, US

(21) Appl. No.: 11/099,105

(22) Filed: Apr. 5, 2005

Related U.S. Application Data
(60) Provisional application No. 60/560,544, filed on Apr. 8, 2004.

(51) Int. Cl. G08B 23/00

(52) U.S. Cl. 340/573.1; 340/531; 340/567

(57) ABSTRACT

A system that detects the lack of activity during a predetermined time interval and then notifies a third party is described. A sensor provides information to a computer that monitors the level of activity in a given field of view. If no activity has occurred within a user programmed period of time, the device will automatically notify a third party and alert them to the situation.

We claim benefit of provisional patent application Ser. No. 60/560,544 that was filed on Apr. 8, 2004.

### BACKGROUND ART

A great number of older individuals desire to live alone with as much independence as possible. Their family members are often concerned about them becoming injured or ill but have no easy method to check up on them. This is complicated by the long distances that often separate, for example, a parent who has retired to Florida and her adult children who moved to California. If such a person where to become injured or incapacitated, they may not be found for days (unfortunately, such events occur frequently). Numerous approaches to monitoring such people have been tried in the past. These include video monitoring or a device that allows the user wears that enables them to signal for help. However, the individual often resents having to wear a pendant and will not tolerate video surveillance or other traditional monitoring means.

This invention solves this problem in a non-invasive way. A passive sensor, such a an infra-red detector, monitors an area that is regularly used by the individual (for example the kitchen). If there is no activity in that area within a given period of time, it will trigger the alarm condition, causing the device to dial a series of phone numbers and play a prerecorded voice message requesting help. This would greatly reduce the possibility of pain and suffering of the person being monitored as well as reduce the stress level of caretakers. It would also increase their independence, which is the main reason that many people chose to live alone in the first place.

### SUMMARY OF THE INVENTION

This invention monitors a given area for activity and notifies a recipient if there is a extended period of inactivity. The user can program a variety of parameters such as the length of inactivity that triggers an alarm.

### BRIEF DESCRIPTION OF THE DRAWINGS

FIG. 1 Block diagram of the invention

FIG. 2 Preferred embodiment of the invention

FIG. 3 Sample schedule table for use by the microprocessor

### DETAILED DESCRIPTION OF THE INVENTION:

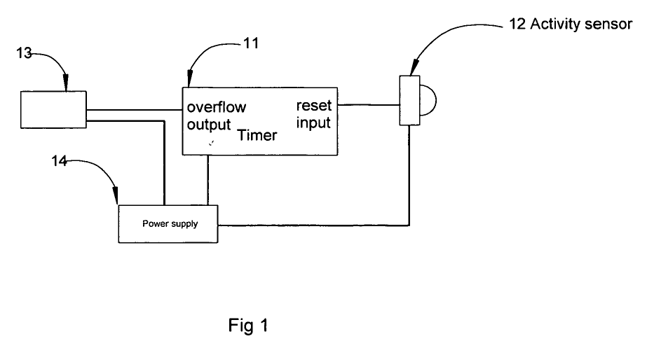

The basic invention is shown as a block diagram in FIG. 1. A timer circuit, 11, such as a 555 timer chip or a microprocessor, is connected to a activity sensor such as a PIR detector or ultrasonic transducer (all of which are commonly understood in the art of electronic design). When sensor 12 detects activity it resets the timer; if no activity occurs within the duty cycle of timer 11, timer 11 overflows (or underflows if a countdown timer is employed) and the timer sends a signal to the communications means 13. Communications means 13 could be a telephone dialer circuit, a remote alarm or numerous other means commonly employed to sound an alarm. This informs the recipient that no activity has occurred within the allotted time period. Optionally, the timer duty cycle could be user adjustable and a manual reset button included.

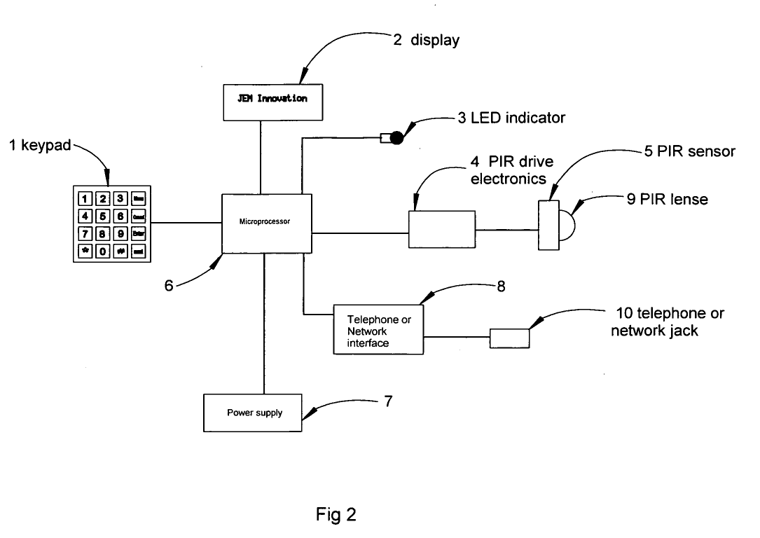

A block diagram of the preferred embodiment is shown in FIG. 2. The system is comprised of an infra-red detector, a microprocessor, a keypad, an LCD display, a telephone interface circuit, a dialer circuit and power supply. An alternative design could use a network connection such as Ethernet or a wireless connection such as Bluetooth (both are common in the art). The microprocessor would typically be a device such as the Atmel ATMEGA169 which has all required memory, timers, oscillators, Input/output pins built in to it. These are also common in the art and are available from numerous vendors.

During installation, the user will enter a multiplicity of phone numbers into the microprocessor memory via the keypad and display. They will optionally enter a ‘time out’ interval and optional schedules. They shall also connect the device to a network via a cable.

The firmware required for the microprocessor could be written in the ‘C’ programming language or in an Assembler. Both of which are now standard in the industry and well know to anyone skilled in the art.

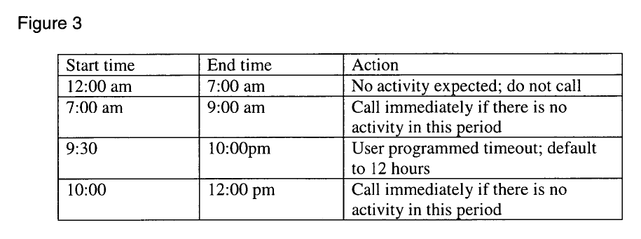

Once enabled, the microprocessor will monitor activity within the field of view of the Infra-red sensor. (Such sensors are typically pyroelectric infra red devices and are commonly known in the art. However, microwave, ultrasonic and other transducers could be used.) It will record activity events and compare these events against the pre-programmed schedule. A sample schedule is shown in FIG. 3. Note that the schedule could include different time slots for different days of the week etc. If no activity occurs within the time programmed into the schedule, the device will start dialing the phone numbers stored in memory. Using a voice generator, it will play a message requesting help. It could also play back a pre-recorded message that had been stored in memory.

It is envisioned that this device could be disguised as a knick-knack or a figurine, such as a porcelain cat, a stuffed animal etc. It could also be enclosed in a picture frame.

The invention could also be programmed to record the time since the last known activity event and report this to the notified party. It could also be setup to call repeatedly until turned off. This could be accomplished by someone using the keypad attached to the device or remotely via touch tone control.

The invention could also be internet ready as it is expected that some users would prefer notification via email or the internet. By including a web server or email program the device could easily send an electronic message via email or a pager. Users could monitor the activity records by logging in via the internet connection. In addition, they could reprogram the inactivity schedule remotely. For example, if Grandma was away on a trip for a few days. While “netcams” are common they require that the viewer time their access to ‘catch’ the subject in view. This invention would simplify things by presenting a table of the last several days or hours of activities.

An advanced version of the device could use a plurality of wireless transmitters that would link to a central controller. The central control unit would monitor and track the information from all remote units and activate the alarm mechanism if the activity schedule had been violated. Such remote units are common in the alarm industry and generally included encrypted messages to prevent interference from other similar units (say from the neighboring apartment).

The invention could also incorporate a ‘panic’ button to force an immediate call for help. Such buttons could be located on the unit. They could also be located remotely and connected via wireless or wired signals.

The invention could also be programmed to trigger an alarm condition if a child were to leave their bed or crib.

1. A device that monitors an area for activity and reports via a communications means if activity has not occurred within a specific time period. Such device comprising:
a. A sensor means for detecting activity.
b. A means of sending a message or alarm.
c. A power supply means.
d. A timing means to measure the time since the last detected activity.
e. A means to compare the length of in-activity to a preset value and generating an alarm condition if the preset value is exceeded.

2. The device of claim 1 that includes a means for displaying the configuration and status information.

3. The device of claim 1 that includes a means for entering data.

4. The device of claim 1 that includes a storage means for recording events.

5. A device of claim 1 that is enclosed in a housing that resembles a knickknack commonly found in a residence.

6. A housing of claim 5 that is a picture frame.

7. A communications means of claim 1 that uses a standard dial up phone line.

8. A communications means of claim 1 that uses a computer network.

9. A communications means of claim 1 that is wireless such as a cellular phone.

10. A sensor of claim 1 that is infra-red.

11. A sensor of claim 1 that is ultrasonic.

12. A sensor of claim 1 that is an interruptible light beam.

13. A sensor of claim 1 that is a switch that is tripped unconsciously such as a floor matt.

14. A means to enter information of claim 1 that is remote via a network.

15. A sensor of claim 1 that is physically separate from the means of sending the message.
